(19) United States
(12) Patent Application Publication
(10) Pub. No.: US 2004/0131533 A1
(43) Pub. Date: Jul. 8, 2004

(54) Extrusion of graphite bodies

(76) Inventors: Christopher John Spacie, Swansea Wales (GB); Anthony Berian Davies, Swansea Wales (GB); Simon Butler Cannon, Kidderminster England (GB); Robin Stuart Hopker, Swansea Wales (GB); Iain Campbell Alexander, Kidderminster England (GB); Alan Robert Begg, Kenilworth Warwickshire England (GB); James Charles Boff, Pinner Middlesex England (GB); Philip Beaton Brown, Worcester England (GB); Laurence Miller Bryce, Gosport Hampshire England (GB); Mark Christopher Turpin, Loughborough Leicestershire England (GB)

Correspondence Address: JOHN S. PRATT, ESQ, KILPATRICK STOCKTON, LLP, 1100 PEACHTREE STREET, SUITE 2800, ATLANTA, GA, 30309, US

(21) Appl. No.: 10/475,644

(22) PCT Filed: Apr. 30, 2002
(86) PCT No.: PCT/GB02/01977

(30) Foreign Application Priority Data
May 3, 2001 (GB) 0110917.2

(51) Int. Cl. C01B 31/04; B29C 47/00; B29C 47/14; B29C 47/20; B29C 47/76; B29C 47/88

(52) U.S. Cl. 423/448; 264/29.1; 264/293; 264/129; 264/211.11; 264/209.1; 264/146; 264/102; 264/105; 264/211

(57) ABSTRACT

A method of forming graphitic bodies comprises the steps of:—

a) forming under high shear a mouldable composition comprising:—

i) graphite powder;

ii) a binder; and

iii) a fluid carrier

b) working under high shear said mouldable composition to form an extruded shape;

c) forming bodies from said shape; and

d) heat treating said bodies to stabilise the structure.

In which either the fluid carrier is an aqueous fluid carrier, and/or the bodies are impregnated to close porosity and/or the bodies are machined to form structures in their surface.

This invention relates to the extrusion of graphite and is particularly, although not exclusively, applicable to the manufacture of graphite components for fuel cells, for example polymer electrolyte fuel cells. The term extruded is to be interpreted in its broadest sense as meaning any process in which a formable composition is forced through a forming aperture (e.g. a die or a space between rollers) to form a body having a desired cross section.

Fuel cells are devices in which a fuel and an oxidant combine in a controlled manner to produce electricity directly. By directly producing electricity without intermediate combustion and generation steps, the electrical efficiency of a fuel cell is higher than using the fuel in a traditional generator. This much is widely known. A fuel cell sounds simple and desirable but many man-years of work have been expended in recent years attempting to produce practical fuel cell systems.

One type of fuel cell in commercial production is the so-called proton exchange membrane (PEM) fuel cell [sometimes called polymer electrolyte or solid polymer fuel cells (PEFCs)]. Such cells use hydrogen as a fuel and comprise an electrically insulating (but ironically conducting) polymer membrane having porous electrodes disposed on both faces. The membrane is typically a fluorosulphonate polymer and the electrodes typically comprise a noble metal catalyst dispersed on a carbonaceous powder substrate. This assembly of electrodes and membrane is often referred to as the membrane electrode assembly (MEA).

Hydrogen fuel is supplied to one electrode (the anode) where it is oxidised to release electrons to the anode and hydrogen ions to the electrolyte. Oxidant (typically air or oxygen) is supplied to the other electrode (the cathode) where electrons from the cathode combine with the oxygen and the hydrogen ions to produce water. A sub-class of proton exchange membrane fuel cell is the direct methanol fuel cell in which methanol is supplied as the fuel. This invention is intended to cover such fuel cells and indeed any other fuel cell in which graphitic components are usable (e.g. alkaline fuel cells).

In commercial PEM fuel cells many such membranes are stacked together separated by flow field plates (also referred to as bipolar plates). The flow field plates are typically formed of metal or graphite to permit good transfer of electrons between the anode of one membrane and the cathode of the adjacent membrane. The flow field plates have a pattern of grooves on their surface to supply fluid (fuel or oxidant) and to remove water produced as a reaction product of the fuel cell.

To ensure that the fluids are dispersed evenly to their respective electrode surfaces a so-called gas diffusion layer (GDL) is placed between the electrode and the flow field plate. The gas diffusion layer is a porous material and typically comprises a carbon paper or cloth, often having a bonded layer of carbon powder on one face and coated with a hydrophobic material to promote water rejection.

An assembled body of flow field plates and membranes with associated fuel and oxidant supply manifolds is often referred to a fuel cell stack.

The grooves on the flow field plates have to be precisely machined and the flow field plates are conventionally made by the process of:—

a) Forming a body of graphite precursors;

b) Heat treating to remove volatiles (in this step carbonisation occurs)

c) Graphitising said body at elevated temperature (˜2000° C.-˜2500° C.);

d) Cutting plates from said body;

e) Milling grooves in said body; and,

Resin impregnating the milled body to close any residual porosity.

This is process has several disadvantages, including:—

a) Graphitising at high temperature is a time consuming and costly process;

b) Because the plates are cut from a larger body uniformity is difficult to achieve (the density and structure at the middle of a large graphitised body will differ markedly from the density and structure towards the edges of such a body);

c) Milling to the tolerances conventionally required is expensive;

d) A lot of waste material is produced that is not readily re-usable; and

e) The process is inherently a batch process and not well adapted to automation on a production scale.

Although the technology described above has proved useful in prototype and in some limited commercial applications, to achieve wider commercial acceptance there is now a demand to reduce the cost of the components while maintaining if possible the dimensional tolerances required.

Suggested methods for forming such plates include embossing compressible expanded graphite containing plates, as disclosed in WO 95/16287. WO 00/41260 claims that such expanded graphite containing materials are particularly suitable for forming fine surface features by methods such as moulding, rolling or embossing. The low conductivity of such materials is a drawback to their use and the compressibility of the material leads to low mechanical strength. Additionally, compressible graphite materials suffer from the problem that they are compressible! When the stack is assembled the cells are compacted at very high loads (200N/cm² is typical). Such materials are not dimensionally stable under this pressure and the gas tracks tend to close up.

Other systems proposed for making the plates include the use of carbon/fluorocarbon polymer composites as described in U.S. Pat. No. 4,214,969. However, polymers containing even a low loading of conductive particles suffer from strength problems, and therefore the addition of a further component such as carbon fibre, as disclosed in U.S. Pat. No. 4,339,332, is necessary to provide adequate material properties.

The inventors have realised that extrusion provides a route for the production of graphite plates having a low electrical resistivity. Extrusion should be taken to include visco-plastic processing. Visco-plastic processing is a process, used in the manufacture of ceramics, in which a particulate ceramic is mixed with a liquid medium to form a viscous composition which can be extruded, pressed, moulded or otherwise formed in like manner to rubbers and plastics. European Patent EP-A-0183453 discloses such a process in which the particulate ceramic material comprises at least 50% by volume of the composition and in which the particulate ceramic material has a mean aspect ratio of less than 1.70.

Extrusion is a process used in the manufacture of electrical carbons (blushes for motors, pantographs, current collectors, and similar articles where the electrical conductivity of carbons is used). To understand why graphite is not conventionally extruded requires an explanation of this related process.

A typical (non-extrusion) process for the manufacture of electrical carbons comprises the steps of:—

a) Forming a mixture of coal tar pitches and carbon black;

b) Heating to 1300° C. under a protective atmosphere to remove volatile materials and produce a coke comprising approximately 99.5% carbon;

c) Grinding the coke;

d) Blending the ground coke with more coal tar pitch to form a blend;

e) Pressing the blend to form blocks;

f) Firing at 1300° C. under a protective atmosphere to form a carbon block;

g) Graphitising the block at ˜2200-˜2800° C. under a protective atmosphere;

h) Cutting the block to form articles from the block; and optionally

i) Impregnating the article with resin or metal.

This complex process reflects the complex nature of carbon, in which the processing temperature affects radically the degree of graphitisation and hence the electrical and mechanical properties of the formed product.

In this process it is possible, rather than pressing a block, to extrude the blend to produce extruded shapes, typically having cross sectional dimensions of the order of 1-10 cm (e.g. having a rectangular cross section 3 cm by 5 cm). However if, experimentally, graphite is used in the blend, in place of the coke, then the extruded article cracks badly. If graphite could be extruded then this would avoid the need for the time consuming and expensive graphitisation step.

The inventors have realised that the reason that graphite extruded products crack is poor mixing of the graphite with the pitch binder. By achieving more intimate mixing, the problem can be overcome. In addition, if the article to be extruded is itself formed under high shear (for example by extruding through an aperture having at least one dimension below 4 mm, preferably below 2.5 mm) further intimate mixing and alignment of the graphite can occur in the extrusion step itself. The high shear working step also forces the material together so that it binds and provides a degree of de-airing.

Subsequently the inventors found GB2240006, which discloses a process for the manufacture of carbonaceous diaphragms for use in acoustic equipment in this process 90-10% of organic high polymer is mixed with 10-90% of graphite under high shear; palt of the mixture is extruded to form a honeycomb core; a sheet of the mixture is formed under high shear (e.g. by rolling); the sheet is contoured to the shape of the core to produce a skin. The assembled article is then fired at high temperature of 1000° C. to 1500° C. In this document the sheet was an intermediate product and on firing would produce a porous material. The usefulness of the sheet material, of itself rather than as an intermediate product, was not recognised in GB2240006.

GB22440006 also used organic solvents such as dibutyl phthalate (a known reproductive toxin), as plasticisers, which were driven off by heating. Such organic solvents can constitute a health hazard and it would be advantageous to use a'solvent that minimises or controls the use of hazardous organic solvents.

Accordingly, in a first aspect, the present invention provides a method of forming graphitic bodies comprising the steps of:—

a) forming under high shear a mouldable composition comprising:—

i) graphite powder;

ii) a binder; and

iii) an aqueous fluid carrier

b) working said mouldable composition under high shear to form an extruded shape

c) forming bodies from said shape; and

d) heat treating said bodies to stabilise the structure.

By an aqueous fluid carrier is meant a fluid material comprising >10% by weight water. Preferably water comprises >30% by weight of the aqueous fluid carrier and still more preferably comprises >60% by weight of the aqueous fluid carrier.

The bodies may be machined to form features in their surface before and/or after heat treatment. The bodies may also be impregnated to close porosity in the bodies, and this can occur before and/or after any machining.

In a second aspect, the present invention provides a method of forming graphitic bodies comprising the steps of:—

a) forming under high shear a mouldable composition comprising:—

i) graphite powder; and

ii) a binder; and

iii) a fluid carrier

b) working said mouldable composition under high shear to form an extruded shape

c) forming bodies from said shape;

d) heat treating said bodies to stabilise the structure; and

e) impregnating the bodies to close porosity in the bodies.

In a third aspect, the present invention provides a method of forming graphitic bodies comprising the steps of:—

a) forming under high shear a mouldable composition comprising:—

i) graphite powder; and

ii) a binder; and

iii) a fluid carrier

b) working said mouldable composition under high shear to form an extruded shape

c) forming bodies from said shape;

d) heat treating said bodies to stabilise the structure; and

e) machining the bodies to form features in their surfaces.

In the second and third aspects, the fluid carrier may be an aqueous carrier, an organic solvent based carrier as used in GB 2240006 or may be a pitch or tar based carrier. Where the carrier is an organic solvent based carrier or a pitch or tar based carrier, the carrier itself can act as a binder.

In a fourth aspect, the invention extends to methods of making a range of products, as specified below and in the claims, the method comprising the steps of:—

a) forming under high shear a mouldable composition comprising:—

i) graphite powder;

ii) a binder; and

iii) a fluid carrier

b) working said mouldable composition under high shear to form an extruded shape;

c) forming bodies from said shape; and

d) heat treating said bodies to stabilise the structure.

The present invention also comprises a mouldable graphitic material that can be formed to shape and air dried to set.

The step of working the mouldable composition can be by extrusion through an aperture having at least one dimension less than 4 mm, preferably less than 3.5 mm, yet more preferably less than 2.5 mm, still more preferably less than 1.5 mm, to form a plate. The invention is not limited to this feature, and the applicants have successfully extruded 10 mm wall thickness tube which was split and rolled down to 6 mm.

By such a process a highly graphitic body can be formed without the need to undergo a high temperature graphitisation step. Such a process can also be readily adapted to continuous forming of bodies and may be readily automated.

Further features of the invention are set forth in the claims and the following description.

The method of the present invention is described by way of example in the following non-limiting description with reference to the drawings in which:—

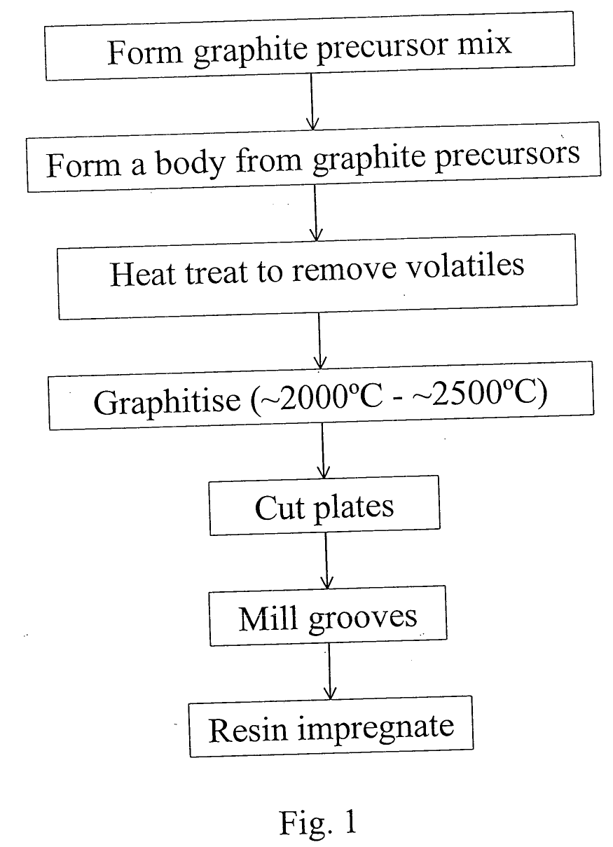

FIG. 1 is a flow chart for the conventional process of forming a flow field plate

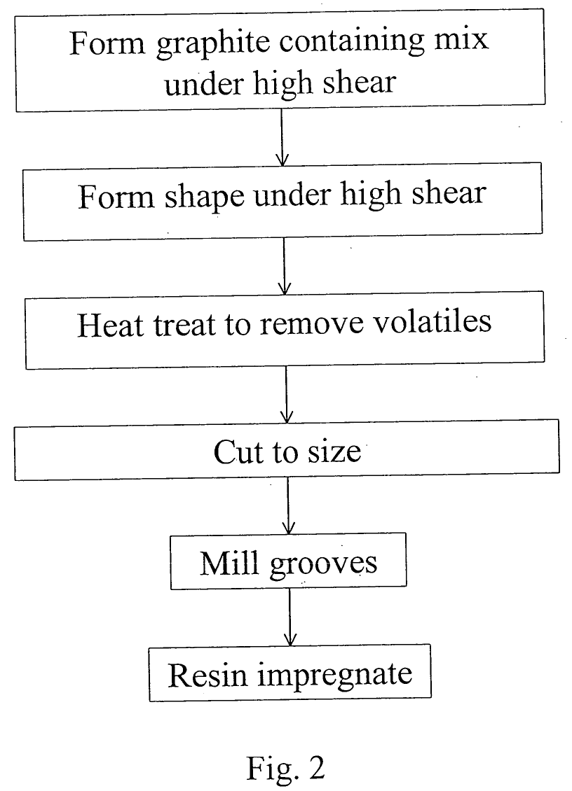

FIG. 2 is a flow chart for a method in accordance with the invention;

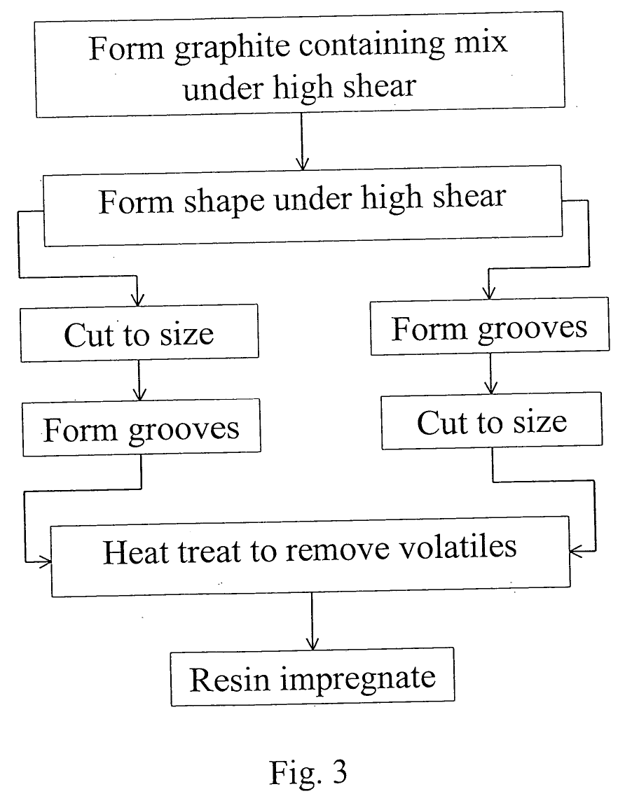

FIG. 3 is a flow chart for a further method in accordance with the invention;

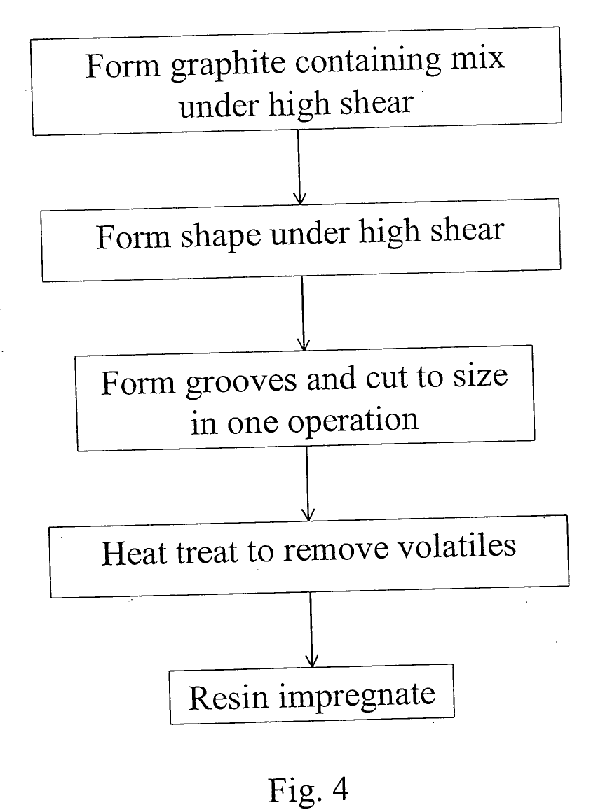

FIG. 4 is a flow chart for a still further method in accordance with the invention;

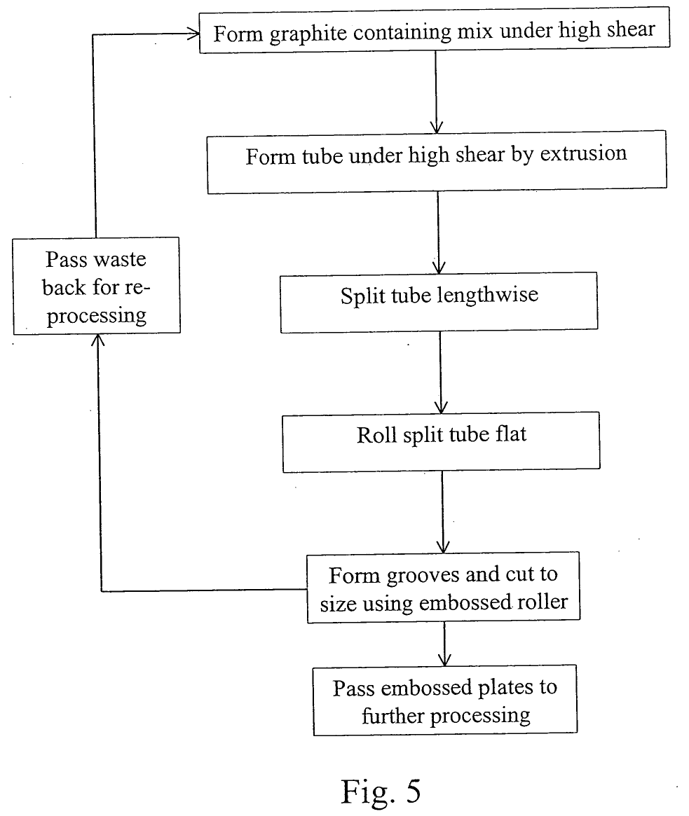

FIG. 5 is a flow chart for a yet further method in accordance with the invention;

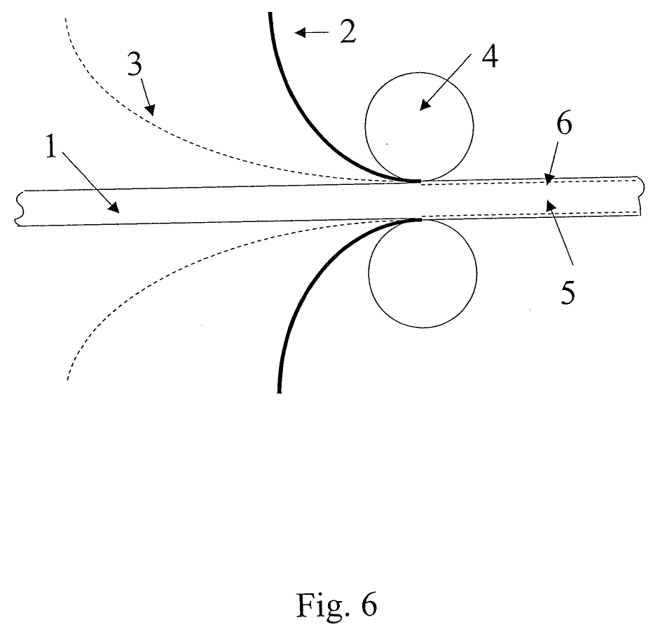

FIG. 6 is a schematic diagram showing a possible method of forming buried voids within an article

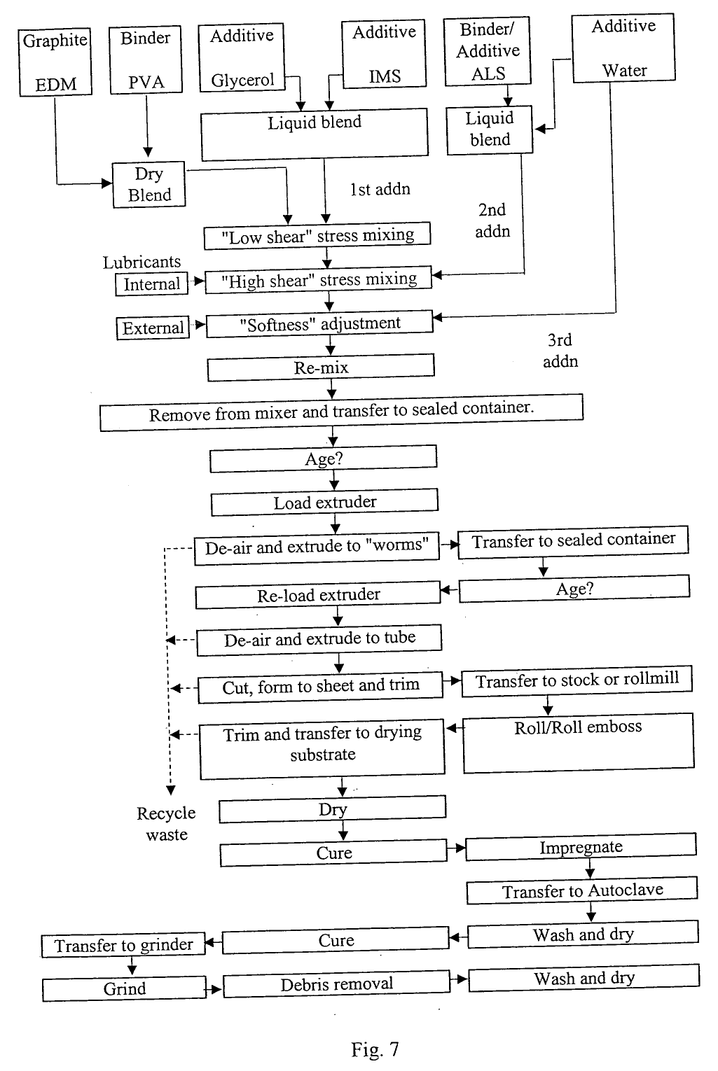

FIG. 7 is a flow chart indicating typical processing steps that may be used in performing the invention

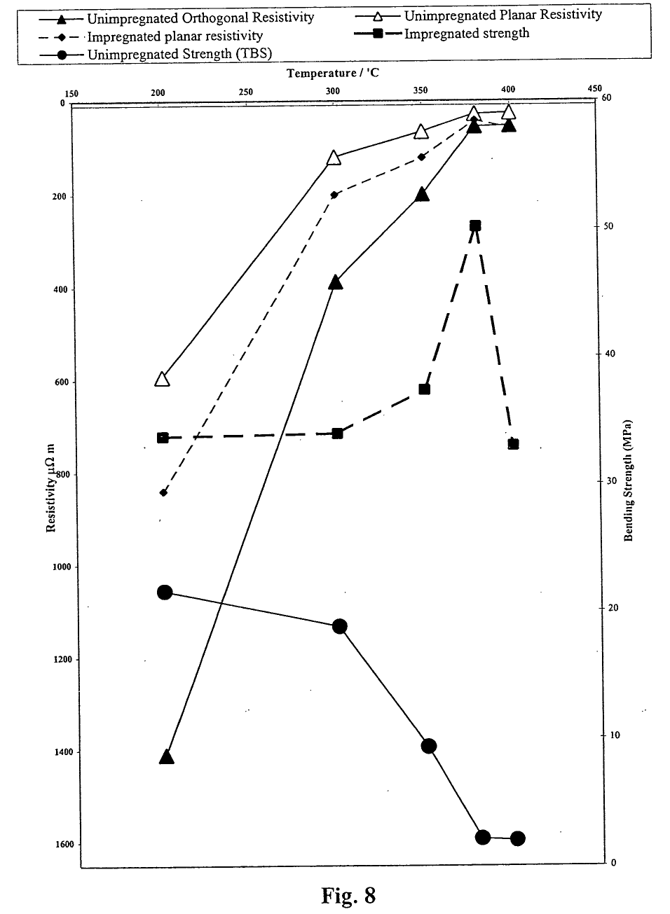

FIG. 8 shows graphically the strength and resistivity obtained upon curing a sample material of the invention at different temperatures.

In FIG. 1 the conventional process of forming a flow field plate described above is shown. This is a seven step process, but it should be noted that to reach the first step of this process (forming graphite precursor mix) many process steps may already have been undertaken. The process of FIG. 1 includes the expensive high temperature graphitisation step.

In contrast, FIG. 2 shows a simplified six step procedure, in which the processing order of the last two steps of the conventional process is maintained, namely that the grooves are milled, and then the plate is resin impregnated. This procedure saves the expensive high temperature graphitisation step.

FIG. 3 shows a further process, in which the processing order of the later steps of the conventional process is not maintained. In this process the grooves are formed in the plate before heat treatment to remove volatiles (and carbonise binder). As shown, the plate is either cut to size before the grooves are formed or the grooves are formed and plate cut to size as convenient.

The grooves may be formed by embossing. For example, an extruded shape may be passed between patterned rollers, which may emboss a grooved pattern into the surface of the shape.

Such a rolling step has the virtue of ensuring that the shape is of connect thickness. The rollers may also simultaneously cut the extruded shape to form separate bodies. Such separate bodies can readily be passed on to a conveyor system for further processing. FIG. 4 shows a flow chart for such a process.

The method of forming sheet material by this process may also lend itself to using such a sheet as a pre-form for die stamping instead of roll embossing. This can help in eliminating some of the potential problems of pressing thin sheet to uniform density.

Alternatively, the rolled sheet may be used as a low cost, crude dimensional tolerance, sheet to feed conventional machining processes.

Forming of the graphite powder containing mix under high shear is performed by using a high shear mixer; for example such as a Farrell type mixer as used in plastics and rubber compounding. A twin roller mixer in which the materials are forced through a narrow aperture between two rollers is also usable. A high shear action sufficient to break up any agglomerates of the graphite powder and ensure thorough mixing with the fluid carrier is necessary, as an intimate and homogeneous dispersion of the components is required. Other mixers suitable for this purpose include Francis Shaw mixers (http://www.farrel.com/intermix/Intermix.html), and Banbury mixers (http://www.farrel.com/banbury/Banbury.html). A twin screw extruder could possibly give sufficient shearing action for this mixing step.

The graphite powder used may be natural graphite, or artificial, or mixtures of both. Suitable grades include Lonza KS6, Branwell Hll(H) and others (see Table 1 below).

TABLE 1

| | | | | | Approx- |
|---|---|---|---|---|---|
| | | | | | imate |
| | | | Surface | | Particle |
| | | Nominal | area | Graphite | Size |
| Material | Supplier | purity % | m²g⁻¹ | Type | D₉₀/μm |
| H11(H) | Branwell* | 97-99 | | Natural | 300 |
| HP-H11(H) | Branwell | 99 | | Natural | 300 |
| F11(HP) | Branwell | 99 | 8 to 12 | Natural | 50 |
| F11 | Branwell | 97 | | Natural | 50 |
| EDM 99.5 | Branwell | 99.5 | 6 to 8 | Natural | 50 |
| (ET67) | | | | | |
| SFG75 | GS | 99.9 | 3.5 | Synthetic | 75 |
| | Inorganic# | | | | |
| T75 | GS Inorganic | 99.9 | 9 | Synthetic | 75 |
| KS75 | GS Inorganic | 99.9 | 8 | Synthetic | 75 |

*Arthur Branwell & Co. Ltd. of Epping, England
#GS Inorganic of Evesham, England

Suitable amounts of graphite are greater than 30% by weight, preferably greater than 60% by weight, still more preferably greater than 80% by weight of the “dry” ingredients.

After compression, graphites expand upon release of the compressing pressure. This is known as “spring back”. For this invention generally, natural graphite is preferred since it exhibits less “spring back” than synthetic graphite, so that upon extrusion or rolling the dimensions of the article produced is more readily controlled.

Natural graphites also tend to have a greater electrical conductivity than synthetic graphites.

However, for some applications where resiliency of the graphite article is required, (e.g. gasketing) synthetic graphites may be superior. Mixtures of graphites, for example mixtures of synthetic and natural graphites, and/or mixtures of different particle sized graphites may be used.

The mixture comprises a material that binds the graphite powder. Advantageously that binder may act as a plasticiser for the composition.

The composition may contain fillers which may be carbonaceous (e.g. cokes, carbon blacks, carbon fibres, nanofibres, nanotubes) or non-carbonaceous (e.g. stainless steel fibres, carbide materials) but which must be selected for suitability for the intended end application.

The process could take two forms:

Type 1.

The extridate requires a heat treatment temperature of typically 800-1300° C. to ensure the “fluid carrier” is carbonised to improve electrical conductivity (such “fluid carriers” could be pitch, resin, starch etc. After such heat treatment it will usually be necessary to fill porosity with resin.

Type 2.

The extrudate uses a “fluid carrier” that can be thermally stabilised by a low temperature heat treatment (<500° C., preferably <400° C.) and such that the product at this stage has adequate electrical conductivity. The low temperature heat treatment is not likely to produce as high a carbon yield from the “fluid carrier”. A typical “fluid carrier” may be a water based system comprising a thermoset resin, a poly vinyl alcohol, starch derivatives, lignosulphonates or blends thereof as a binder.

Type 1 would potentially reduce the cost when compared with the existing production routes, but greatest savings would be to use a Type 2 process.

The shape is formed under high shear by passing through a narrow gap such as that in an extrusion die or between rollers. The high shear action involved both provides additional mixing and gives some degree of alignment of the graphite with respect to the formed body. This alignment assists in inter-particle bonding as aligned graphite particles will have a greater contact area with adjacent particles than would be expected for randomly aligned graphite particles. The narrow gap may for example be less than 4 mm, preferably less than 3.5 mm, yet more preferably less than 2.5 mm, or still more preferably less than 1.5 mm.

If the extruded material is then rolled this too will provide some high shear mixing.

In forming a sheet of material by this method there will be edge effects at the edges of the sheet as they will not experience the same shear environment as in the middle of the sheet. This problem can be overcome by extruding the sheet in the form of a tube, cutting the tube lengthwise, and flattening the tube to form the sheet. FIG. 5 shows a possible sequence of process steps for this, in which the graphite containing mix is formed by high shear mixing, extruding as a tube, splitting the tube lengthwise, rolling the tube flat to form a flat sheet, embossing and cutting the flat sheet to form plates, and passing the embossed plates on for further processing (e.g. resin impregnation and/or further machining). Waste material at the cutting and embossing step can be passed back to the high shear mixer.

An additional (and commercially important) reason to consider extruding a tube to be split and rolled is because producing sheets for example 40 cm wide by extrusion would necessitate a correspondingly wide extruder aperture. In contrast opening a tube would need a much smaller width aperture (e.g a 12.75 cm diameter tube could be opened to make a ˜40 cm wide sheet). This smaller width aperture means that a cheaper machine can be used.

In looking for suitable extrudable compositions selected materials were mixed in a Z blade mixer and by hand (low shear processes). All were water based and were sealed in polyethylene until extrusion at room temperature as tubes having the inner diameter (id) and outer diameter (od) indicated in Table 2 below. These materials and the outcome of extrusion are indicated in Table 2.

TABLE 2

| | | | | | WATER | | |
|---|---|---|---|---|---|---|---|
| | | | | | % of | Die | |
| Mix | H11(H) | MYLOSE | PVA | ALS | solids | Set | Comments |
| 1 | x | x | | | 16.0% | 27.5 | Tube collapsed upon |
| | | | | | | od | extrusion |
| | | | | | | 16.0 id | |
| 2 | x | x | | | 13.7% | 27.5 | Extruded but friable |
| | | | | | | od | upon cutting |
| | | | | | | 16.0 id | |
| 3 | x | x | | | 11.3% | 27.5 | Extruded but friable |
| | | | | | | od | when cut |
| | | | | | | 16.0 id | |
| 5 | x | | x | x | 25.1% | 27.5 | Good extrusion, |
| | | | | | | od | capable of being cut |
| | | | | | | 16.0 id | and worked |
| 6 | x | | x | x | 20.2% | 25.1 | Not possible to |
| | | | | | | od | extrude |
| | | | | | | 14.1 id | |
| 8 | x | | x | | 13.2% | 25.1 | Not possible to |
| | | | | | | od | extrude |
| | | | | | | 14.1 id | |
| 9 | x | | x | | 8.8% | 25.1 | Not possible to |
| | | | | | | od | extrude |
| | | | | | | 14.1 | |
| | | | | | | od | |
| 10 | x | | x | | 16.0% | 25.1 id | Not tested |
| | | | | | | 14.1 id | |
| 11 | x | | x | x | 16.0% | 25.1 | Short lengths extruded |
| | | | | | | od | |
| | | | | | | 14.1 id | |

Hll(H) is a grade of natural graphite obtainable from Arthur Branwell & Co.Ltd. of Epping, England

The mylose was a laboratory grade mylose.

PVA is a polyvinyl alcohol. The grade used was Gohsenol KH-17S manufactured by Nippon Gohsei of Osaka, Japan

ALS is an ammonium lignosulphonate. The grade used was Tembind A002 manufactured by Tembec Chemical Division of Quebec, Canada.

It should be noted that although some materials were extrudable, the material structure was significantly flawed after extrusion.

Using the optimum compositions from Table 2 a further batch of material was prepared using high shear mixing for extrusion trials. After mixing, the compound had a plastic nature which was retained by enclosing the material in polyethylene.

The compound was pre-heated and loaded into the extrusion chamber at 50° C. Rapid extrusion was achieved at low pressures. The extruded tube was readily deformed and when split as emerging from the extruder was capable of being simply rolled with moderate pressure.

The tube texture was significantly affected by the quality of the tooling, the compound composition and the uniformity of the temperature.

Overnight storage of material sealed in plastic bags retained flexibility, whilst material air dried stiffened significantly.

The batch had the composition shown in Table 3.

TABLE 3

| Component | Amount | Dry weight percentage |
|---|---|---|
| HLL (H) natural graphite | 9.96 kg | 83% |
| PVA (polyvinyl alcohol) | 1.36 kg | 11% |
| ALS (ammonium lignosulphonate) | 0.68 kg | 6% |
| Water | 2.763 litre | |

and was mixed on a Banbury high shear mixer, and extruded on a Barwell SP100 extruder through a narrow aperture (approximately 5 mm) tool. It was dried at room temperature for approximately 120 hours before heat treatment. In this batch the PVA and lignosulphonate both act as binders and plasticisers.

The heat treatment had a significant effect on in-plane resistivity and strength as indicated in Table 4.

TABLE 4

| Temperature | Resistivity | Strength |
|---|---|---|
| ° C. | μΩm | MPa |
| 180 | 2900 | 26.3 |
| 200 | 1457 | 16.7 |
| 220 | 421 | 16.9 |
| 240 | 340 | ND |

The resistivity range is suitable for fuel cells, some users wanting a low resistivity to prevent parasitic losses in heating the fuel cell stack; others requiring a higher resistivity to provide a degree of heating which may be useful for itself or as an aid to water management.

To investigate post-extrusion forming, extruded “split tubes” were rolled on a twin roll calendering mill. Rollers were approx. 150 mm diameter and with a fixed speed (6 rpm) and speed ratio of 1:1. The rollers were only operated at room temperature. The temperature of rolling will naturally affect the processing of the materials.

Using multiple passes, ‘sheets’ were reduced from approximately 5 mm to approximately 1.3 mm, showing the plasticity of the material. It was noted that the surface texture was degraded by excessive rolling, and typically a reduction in thickness to <40% of original thickness is to be avoided if possible.

In rolling, the materials picked up texture from the rollers, mimicking defects in the rollers. This showed that features could be formed in the material by rolling.

Once such plastic graphite materials are obtained they may be processed by any of the methods traditionally used for rubber and plastics processing.

Such plastic materials containing high levels of graphite would be of great use in the manufacture of fuel cells.

Extruded plates could be made of high quality finish for subsequent formation of flow fields and other features by conventional means or, for example, by the abrasive blasting method of WO01/04982, in which a resist bearing a desired pattern is placed over the plate and abrasive blasting is used to cut away exposed portions of the plate.

Extruded plates could be formed, and flow fields and other features formed by stamping or pressing.

Flow fields and other features could be formed in extruded plates by rolling with a suitably patterned roller.

Sufficiently thin sheets of the material could be used as gasket materials in the construction of fuel cell stacks.

The material may be kept pliable by protection from exposure to air (e.g. by retaining in a container, for example a plastics bag), and when required removed from its container, cut to shape, and applied to the flow field plates or otherwise used.

If the mix includes a suitable sacrificial material (e.g. low-melting point polymer dust) that melts or burns or otherwise disappears at or below the intended heat treatment temperature, then porosity may be introduced into the material. This would be useful in the preparation of gas diffusion layers for fuel cells. Other temporary secondary phases could be included, either in forming the material or post heat treatment, for a variety of uses—e.g. as catalytic, chemically active, or electrically active materials; or as slow release materials, (e.g. for perfumes).

A similar approach could also be used to form buried flow field patterns as is indicated in FIG. 6, in which a band or thick sheet 1 of the plastic graphite material and sheets 2 of the plastic graphite material are sandwiched with a mesh 3 of a sacrificial material (e.g. a low temperature melting plastics material). Rollers 4 press the thick sheet 1, sheets 2 and mesh 3 together to form a composite sheet 5 having a buried mesh 6. On heat treatment the sacrificial material melts, burns or otherwise disappears to leave a pattern of voids below the surface. If the sheets 2 themselves contain sacrificial material then the surface forms an integral GDL. Otherwise, the surface of the composite sheet 5 can be perforated by any suitable machining method (e.g. abrasive blasting through a resist) to make contact between the voids and the surface.

Such plastic materials containing high levels of graphite (or of carbon) would also be useful in other applications such as in heat management, as heat shields, and as a part of carbon-carbon composite materials (e.g. forming a skin to a felt or porous carbon body).

The extrudable materials themselves advantageously comprise a liquid carrier, graphite, a polymer binder to give rigidity when dried, and a plasticity improving component. The polymer binder may be the same material as the plasticiser. The polymer binder/plasticiser preferably burns off at the heat treatment temperature of <500° C. (preferably <400° C., usually above 150° C. and typically 200-350° C.) and in burning off may contribute some carbon char to the structure formed.

To investigate the process conditions for forming such materials a series of further tests were made. A number of compositions were made using PVA and ALS as a binder and it was determined that the process steps necessary to form a sheet of graphite material were highly dependent upon the materials used.

A typical formulation for the mouldable composition for fuel cell applications would comprise in weight percent (as a proportion of the components excluding the fluid carrier):—

| | |
|---|---|
| Graphite | 80-90% |
| Binder | 10-20% |
| Plasticiser | 0-10%. |

to which a fluid carrier in amounts typically in the range 10-40% (preferably in the range 15-35%) by weight of the total of said components is added in mixing.

A proportion of the graphite (e.g. 10%) could be substituted by materials such as coke to disrupt the alignment of the graphite and improve (lower) through-plane resistivity of sheets formed from the material. However this can deleteriously affect extrusion properties. For other applications where resistivity is not so critical higher proportions of graphite can be replaced.

The binder needs to be of a nature that will ensure sufficient strength in the extruded material for handling, and yet permit extrusion of the material in the first place. The applicants experimented with varying the ratios of the polyvinyl alcohol (PVA) and ammonium lignosulphonate (ALS) mentioned above.

When the PVA alone was used as a binder, the extruded material showed cracking of the extrudate and a crumbly texture. When the ALS was used alone as a binder the mixture produced had an elastomeric texture that was not suitable for maintaining dimensional tolerances on extrusion. A mixture of the two materials gave good properties as a binder.

The applicant's hypothesis is that the PVA acts as a binder maintaining short range binding between adjacent particles of graphite, whereas the ALS acts to provide some longer range stability and also acts as a plasticiser. The applicants believe that a similar result would be obtained if another long chain molecule was used in combination with the PVA to replace ALS in whole or in part, erg. polyethylene glycol. However, ALS has the advantage that on heat treatment it is likely to leave a significant amount of carbon char that assists in binding the heat treated material.

ALS is generally used as a surfactant material and its use as a binder in this sense is unusual. Lignosulphonates are materials obtainable from wood and are available from both hard and soft woods. Lignosulphonates may be modified and include altered cations. For the present invention all lignosulphonates may be used, modified or unmodified, and may include any suitable cation or cations, for example calcium, magnesium, ammonium and sodium For fuel cell component applications ammonium lignosulphonate is preferred.

The invention is not limited to the use of PVA as a binder, nor indeed to the use of thermoplastic binders, and thermoset binders may also be used.

Once dried and heat treated the material may require impregnation (e.g. with resin or metal) to fill any remaining porosity.

FIG. 7 indicates typical processing steps that may be used in performing the invention.

Important variables in the liquid mixing stage include: the order of addition of components; the temperatures of the components; amount of air introduced during the mixing process; effect of rheology on mixing efficiency; shear in mixing, and time of mixing.

In the process indicated, the dry ingredients of graphite and part of the binder system (in this case PVA) are mixed in a dry mixer. A typical mixing time for small scale mixing is 3 to 12 minutes,

Glycerol and industrial methylated spirits (IMS) are mixed to form a first liquid mixture, and hot water (typically >40° C. e.g. 60° C.) and ammonium lignosulphonate (ALS) are mixed to form a second liquid mixture.

The first liquid mixture is then added to and mixed with the dry ingredients. The mixing may take place in the high shear mixer (e.g. a Banbury mixer). Because the mixing cavity is not full at this stage, mixing will be relatively low shear as the ingredients are not forced between the mixing blades/vanes/rollers of the mixer and are rather stirred together.

The industrial methylated spirits in the first liquid mixture serves as a dispersant for the PVA binder so that when further water is added it wets the PVA in a controlled manner. Without industrial methylated spirits, the PVA tends to form lumps when water is added. Other solvents that are miscible with water may be used for this purpose, e.g. alcohols such as propanol.

The glycerol in the first liquid mixture acts as a plasticiser and other plasticisers can be used, e.g. ethandiol (ethylene glycol).

After this low shear mixing step the second liquid mixture is added. Addition is preferably in a controlled manner. Addition of the liquid all at once can lead to poor mixing as the liquid can then, in effect, form a first phase that lubricates “lumps” of powder so that intimate mixing is not achieved. This results in a “soft” mix of low viscosity having hard lumps in it. Preferably, by adding the liquid slowly, intimate mixing occurs without segregation of the liquid and the powder. Such intimate mixing results in a stiffer but more even mix. [Any cook who has made a flour based batter will understand this phenomenon].

At this stage high shear mixing occurs such that the mixture is forced between the blades/vanes/rollers of the mixer. For some materials it may be found necessary to provide internal lubricants at this stage to assist motion of the particles of the mixture. Polyethylene glycol wax and stearic acid have been tried by the applicants at low levels but no improvement was found for the mixes tested.

Mixing is best done with a stiff mixture to improve the high shear action but extrusion may require a softer mix. When the mixture is adequately mixed, additional water may be added to ensure that it is of adequate softness for extrusion. This may result in stickiness of the mixture as liquid comes to the surface of the mixture rather than remaining within the mixture between the solid particles of graphite. An external lubricant may be necessary at this stage to reduce stickiness.

Typical mixing times for small scale manufacture is 5-45 minutes. The plasticity and subsequent electrical properties of the materials appear to be highly dependent upon the quality of the mixing process. A change in ingredient, such as type or size of graphite, modifies the extrusion characteristics due to the altered rheology of the mix and consequently requires an alternative mixing procedure. For a given set of ingredients a degree of experimentation will be required to determine the appropriate mixing regime to enable good extrusion of the product.

The above procedure mixes the PVA binder with the graphite, and then adds the glycerol/IMS mixture. An alternative approach is to blend the PVA with the glycerol, blend that mixture with an excess of the IMS and then de-aerated under vacuum to both de-aerate the mixture and recover the excess IMS. The mixture is then warmed (e.g. to ˜70° C.) to improve the dissolution of the PVA in the IMS. This mixture can then be blended in the high shear mixer with the graphite and any internal lubricants.

The applicants have found that if the route in which dry PVA is mixed with graphite is used, then the dry PVA should preferably be as fine as possible to provide good mixing and reduce the risk of lumps of PVA appearing. If however the wet route is used, in which the PVA is mixed with the IMS first, then the size of the PVA is not so relevant. If the dry PVA route is followed care should be taken that the PVA is kept dry before use so that agglomeration of the PVA particles does not occur.

The flow sheet of FIG. 7 shows a re-mixing stage which may be required if the initial mixing is inadequate. High shear mixers act by continuously working the material under high shear, folding the material, and reworking it. Although designed to provide an even mixture this pattern of action may result in inhomogeneities in the mixture. By simply removing the mixture and then replacing it in the mixer the extent of inhomogeneity can be reduced.

Once mixed, the mixture may need to be stored before extrusion. If so, storage is preferably in a sealed container to prevent loss of water.

An ageing step is shown. Although high shear mixing is thorough, it may be found that with some materials a period of standing to allow diffusion or reaction of components is advisable. Typically, a one week aging period improves mixes in which the coarse HLL graphite is used, different graphite sizes will result in different aging periods;

A problem that can arise is the incorporation of air into the mixture and it may be necessary to de-air the mixture before final extrusion. To effect this, the flow chart shows a step of extruding through a die to produce “worms” of the material. This shortens the pathway for escaping air and the worms can be stored in a sealed container to allow this to occur. Ageing occurs at this stage also. This process has other advantages that have proven useful. Stresses developed during mixing are evened out, and on latter extrusion to tube it may be seen that distortion in the tube is reduced over a tube from an un-wormed mix.

Having produced a mixture for extrusion, this may conveniently be extruded as a tube as discussed above. With a twin screw extruder some de-airing may occur at this stage. Important parameters that require control at this stage include: effect of rheology on the extrusion process; separation of components; stickiness of the mixture; extrusion pressures; extrusion temperatures; and die design.

The applicant has found that in extruding a tube, die design is important. In a tube die there is generally a central mandrel, defining the bore of the tube, which is held by several arms within the body of the die. These arms are sometimes referred to as a “spider”. As the graphite containing mixture is extruded past these arms it splits and then re-unites within the die. The plate-like nature of graphite particles means that there is a degree of re-alignment where the graphite passes the spider and this introduces lines of weakness in the tube. Accordingly one may use a die with a single arm and then cut the tube along the line of weakness.

After extrusion as a tube, the tube can be cut and formed into a sheet. The sheet can then be rolled and optionally embossed.

Important parameters during the rolling step include: rolling speed; roller temperature; mechanical properties of the mixture; and adhesion to rollers.

During the rolling step dampening and/or lubricating of the surface of the material and/or the rollers may be required to reduce the risk of particles being pulled out of the material on separation from the rollers. This problem tends to occur if the extruded material is stored for a long period after extrusion but is less likely if the material is rolled freshly after extrusion.

The rolled sheet is then dried and this may be by any suitable method. The applicants have used drying in a kiln with the sheet supported on a drying surface. This may be a porous material (e.g. porous ceramic or porous carbon), a mesh, or a perforated plate. The applicants have had good results with a perforated stainless steel plate having >40% open area and a hexagonal array of holes having a size of ˜6 mm diameter. The sheets may need turning during drying, or drying between two drying surfaces, to prevent curling of the sheet as it dries. A typical drying and curing cycle for the HLL graphite rolled sheets comprises the steps:—

Air dry at room temperature overnight or 12 hours which ever is the longer

Oven dry at 45° C. for 12 hours, then 65° C. for 12 hours,

Ramp at 0.2° C./min to 380° C. for 30 minutes soak

Natural cool to room temperature

but of course the optimum drying and curing cycle will vary with composition of the mixture. For finer graphite rolled sheets (e.g. EDM graphite) a slower drying step, for example 16 hours at 45° C. and 16 hours at 65° C. , may be required to reduce the risk of blistering. [The finer graphite means finer porosity and this slows the escape of volatiles during the heat treatment].

The rolled sheet can then be impregnated under vacuum with resin to close the porosity.

The sheet is immersed in resin (typically an epoxy resin or phenolic resin) under vacuum so that on release of the vacuum the resin is driven into the pores of the sheet. To ensure thorough impregnation, the sheet may be placed in an autoclave under pressure (e.g. 80 psi [˜0.55 Mpa]) so that the resin is driven into any vacant porosity.

A wash and dry step with non-aqueous solvent (e.g methyl ethyl ketone) may be of advantage at this stage prior to curing as this can reduce the leachable ion content of the material, which is of advantage when making flow field plates for fuel cells.

Curing of the impregnated resin takes place at an appropriate temperature, e.g. ˜180° C. for 10 hours for an epoxy resin.

The rolled sheet may then be machined, debris removed (e.g. by air blast) and then washed.

To make a flow field plate for a fuel cell (or indeed other graphitic components for fuel cells, e.g. separators), various physical parameters have to be met. For example, the flow field plate must be strong enough mechanically to withstand handling, and must have an adequate electrical conductivity. Typical parameters are:—

Have a bending strength (three point bend) above 30 MPa,

Have an in-plane resistivity below 1000 μΩm,

Have a through-plane resistivity less than 500 μΩm

The applicants have found that, for a given mixture, these parameters are interrelated.

The in-plane resistivity (planar) and through plane resistivity (orthogonal) differ because in the high shear forming step the graphite becomes aligned. As graphite in itself is a highly anisotropic material, this results in anisotropy in the bulk material. For rolled or extruded sheets there may also be differences in properties in the in-plane rolling direction and the in-plane transverse direction, but these tend to be much less than the differences between the in-plane and through-plane properties.

It should be noted that, as extruded, the materials do not have a good electrical conductivity and it is only after the heat treatment that the resistivity is lowered. The applicant's hypothesis is that this is due to the contribution of carbon produced in charring of the binder, and/or through the binder drawing the graphite particles together as the binder chars.

FIG. 8 shows the resistivities and strengths found for a mixture having the components set out in Table 5. The amount of the fluid carrier added constituted 29% by weight of the graphite/binder/plasticiser components.

TABLE 5

| Graphite/binder/plasticiser | Amount | Dry weight percentage |
|---|---|---|
| HLL (H) natural graphite | 5.28 kg | 88% |
| PVA (polyvinyl alcohol) | 0.36 kg | 6% |
| ALS (ammonium lignosulphonate) | 0.36 kg | 6% |
| | | Weight percentage of |
| Fluid carrier (solvents) | Amount | wet components |
| Water | 1.131 kg | 65% |
| IMS (industrial methylated spirits) | 0.609 kg | 35% |

Plates were cut from extruded mix and dried at room temperature for 10 hours, at 45° C. for 6 hours and at 65° C. for 6 hours. The green material had a density of ˜2.73 g·cm⁻³. The sample sheets were cured for 240 minutes at the temperatures indicated and resistivities and strengths measured. Some samples were unimpregnated after curing and others were impregnated with resin in the manner described above.

As can be seen, as the curing temperature increases, the resistivity falls (inverse axis used in FIG. 8), but so too does the strength of the unimpregnated material. However, impregnation with resin leaves the resistivity practically unchanged, while providing a strong material having a strength above 30 MPa.

### SPECIFIC EXAMPLES

As specific examples of moulded graphite sheets made by the process of this invention, two graphites were used to produce sheets.

The Recipes

Recipe 1. A high purity version of Hll(h) graphite obtained from Branwell Graphites. This is a natural flake graphite with a d₅₀ of about 200 μm

Recipe 2. A high polity version of EDM 99.5 graphite obtained from Branwell Graphites. This is also a natural flake graphite but with a d₅₀ of around 16-21 μm

The binder system used for these materials was a combination of:

a) PVA from Gohsenol, grade KH17s added as the main binder.

b) ALS from Tembec Avebene, France added as a secondary binder, surfactant and carbon precursor.

c) IMS from Merck Ltd added as a dispersant.

d) A low water content Glycerol from VWR international Ltd added as a plasticiser and dispersal aid.

Each graphite required a variation of the recipe. For these two graphites, the recipes were as shown in Table 6.

TABLE 6
Recipe 1
Graphite/binder/plasticiser (parts by weight)

| | |
|---|---|
| Hll (h) | 88 |
| PVA | 6 |
| ALS | 6 |

| | | Weight | Proportion of solvents added |
|---|---|---|---|
| Fluid Carrier (solvent) | | percent in solvent | to graphite/binder/plasticiser |
| Water | 18.2 | 65% | 28% |
| IMS | 9.8 | 35% | |

Recipe 2
Graphite/binder/plasticiser (parts by weight)

| | |
|---|---|
| EDM 99.5 | 81.9 |
| PVA | 7.62 |
| ALS | 5.71 |
| Glycerol | 4.76 |

| | | Weight | Proportion of solvents added |
|---|---|---|---|
| Fluid Carrier (solvent) | | percent in solvent | to graphite/binder/plasticiser |
| Water | 19.29 | 62% | 31% |
| IMS | 11.67 | 38% | |

The finer graphite required more binder as it has a greater surface area, and more liquid to act as a carrier for the binder.

Mixing

Using the recipes shown above, firstly the ALS was dissolved in part of the water to form an ALS/Water mixture.

The Graphite and PVA were then dry blended for 10 minutes not exceeding 65° C. using a Banbury type OOC internal mixer to produce a graphite/PVA dry blend. This was so as to break down any agglomerates and produce an intimate mixture of the two materials.

The IMS (and Glycerol for the EDM mix) were then added to the graphite/PVA dry blend, and blended for 5 minutes.

Blending continued with the addition of 60% of the ALS/Water mixture. This was mixed for minutes, the temperature was allowed to rise but kept below 80° C. by water-cooling.

The remaining ALSJWater was then added and mixed for a further 10-12 minutes again kept below 80° C.

A final addition of water was included to adjust the rheology to be suitable for extrusion through the chosen die set. This was mixed in for 5 minutes at less than 80° C. The material required a further short (3-5 minutes) mixing due to the large charge load into the mixer and the size and type of mixer used.

Temperature and time control for these mixes is critical to achieve good extrudable material. Too high a temperature and/or too long mixing, and the final mixture becomes elastic rather than plastic. Too low a temperature and/or too little mixing, and the strength of the final pieces becomes impaired.

Extrusion

First stage in the extrusion process was to “worm” the material. This is where the material is extruded through a large number of small holes in a steel plate (˜60 holes, each of 6 mm diameter and 10 mm long). The process helps to relieve stresses produced during mixing and produces an even thickness of material that can be handled consistently to reload the extruder.

The “worms” so produced were then bagged and sealed then left to stand for one week—this assists in evening out moisture variations.

The “wormed” material was then extruded. The fixed die set used for extrusion of these mixes created a tube with a nominal 4 mm-wall thickness and 75 mm outside diameter. The material was extruded at ram pressures of between about 2 MPa and about 17.25 MPa (300 and 2500 psi) on a 10 cm (4″) ram dependent on the graphite used.

The tube was slit with a knife-edge as it emerged from the die. The tube was opened out into a flat sheet and cut to length. Normal paste extrusion techniques apply here.

Rolling

The roll parameters used were as follows:

Two 150 mm diameter parallel steel rolls contra-rotating at 20 rpm were separated by an adjustable nip gap.

The nip was initially set at 4 mm. The rolls were cooled to 20-25° C.

The sheet material may be dampened with water and lubricated with a thin film of light oil.

The sheet material was passed between the rolls, the nip gap was reduced and the material passed between the rolls once more. This process was repeated several times to provide the reduction required.

It was noted that a reduction of ˜40% is the maximum attainable for these recipes without causing surface degradation.

The nip settings used were, 4.00, 3.75, 3.50, 3.25, 3.00 mm followed by one final reduction to the final thickness required. To establish the final nip setting the thickness of the material was measured and compared with a correlation curve produced from the nip gap setting versus the actual thickness as measured. Extrapolation of the curve provided the setting needed. This curve is unique to each mixture of paste and is dependent on the elastic/plastic nature and rheology of the mix. Knowledge of the particular material allows a factor to be included in the selection of final measured rolled size to account for drying and curing shrinkage.

Drying and Curing

Typical drying and curing cycles suitable for the mixes described above are as follows:

24 hours at Room Temperature,

Step to 45° C., 18 hrs,

Step to 65° C., 12 hrs,

Ramp to 380° C. at 0.2° C./min, for 30 mins, then natural cool

Note:

1. The finer the graphite the longer the room temperature drying time required. Room temperature drying of more than 10 hours is required for “coarse” graphite and somewhere between 12 and 18 hours for the “fine” graphites.

2. Bloating occurs if temperature is raised too quickly over the range 100-130° C. This appears to be due to water egression rather than IMS or Glycerol IMS B.P ˜85° C.-90° C., water B.P ˜100° C., Glycerol B.P 290° C., at around these temperatures the appropriate liquid will expand quickly and press outwards against the structure.

Impregnation

This is required for these two graphite mixtures to improve green and final strength and to close any porosity either partially or fully.

The sheets were placed in a vacuum desiccator and the pressure reduced to around 3 kPa (−29″ Hg) this vacuum was held for one hour. Then, whilst still under vacuum, a low viscosity epoxy resin (with no added solvent) was poured into the container holding the sheets, such that they were fully covered. The vacuum was maintained for another half-hour before the pressure was returned to atmospheric.

The resins used were either a two-part system of Bitrez CPR 600 resin with Bitrez CPH91 hardener (available from Bitrez Limited of Standish, near Wigan, England) or a one part resin Sterling E833, (sourced from P. D. George, St. Louis, U.S.A but originating with Sterling Technology Limited. Manchester, England).

The container holding the sheets, still submerged under the resin surface, was transferred to an autoclave and subjected to an over-pressure of about 0.38 to 0.55 MPa (55-80 psi) for 12 hours.

The time intervals for both the vacuum and pressurisation stages and the values of vacuum and over-pressure are related to the amount of material and surface area of the material being impregnated.

The sheets were then washed with methyl ethyl ketone followed by drying at 110° C. for 10 minutes. The sheets were then quickly transferred to an oven for impregnation resin curing to prevent the resin “sweating” back out of the pores of the material.

The resin cure cycle was as follows unless otherwise specified:

0.7°/minute to 180° C. with a soak 12 hours followed by a natural cool to room temperature.

The samples were then ready for finishing, grinding or other machining operations.

The samples had the properties (strength measured by three point bend) given in Table 7.

TABLE 7

| | | Planar | | Orthogonal | |
|---|---|---|---|---|---|
| | Strength | Resistivity | | Resistivity | Graphite |
| Recipe | Mpa | μΩm | Comment | μΩ · m | type |
| Recipe 1 | 35 | 110 | cured at 10.5° C./hr to | 380 | H11 |
| | | | 200° C. with no soak at | | |
| | | | temperature | | |
| Recipe 1 | 34 | 109 | | 490 | H11 |
| Recipe 2 | 66 | 88 | measured in rolling | to be | EDM |
| | | | direction | measured | |
| | 52 | 107 | measured across rolling direction | | |

The results for Recipe 1 show that variation in the impregnation and curing step has little effect on the properties of the materials provided that a good cure of the resin is achieved.

[It should be noted that resistivity measurements can vary according to the measurement method used and this invention is not limited to any particular value for the resistivity of the materials].

To maintain impermeability a second impregnation may be necessary after final finishing operations.

Fuel Cell Applications

The materials of the invention may be used as graphitic components in any fuel cell that requires such materials. The cured material (without resin impregnated) provides a porous material of use in such fuel cells as direct methanol fuel cells. Other typical fuel cell applications are mentioned above.

Non-Fuel Cell Applications

The mouldable compositions described above may also be used as a mouldable graphitic material that can be formed to shape and air dried to set. The drying may be at room temperature. Such materials are of use in many applications.

As mentioned above, the materials of the invention may have application as thermal insulation and/or heat shields. The thermal conductivity of the graphite sheets will show a similar anisotropy to the electrical conductivity, in that thermal conductivity within the plane of the sheet is higher than thermal conductivity through the plane of the sheet. This means that heat originating from “hot spots” can be spread through the plane of the sheet, the sheet in effect acting as a planar heat pipe. This characteristic can also be used to advantage in heat spreaders to remove heat from apparatus generating heat (e.g. computer chips), however the electrical conductivity of the material must be remembered in designing such heat spreaders.

This use of alignment of graphite to give different properties in different directions is known in the manufacture of molten metal contacting apparatus (e.g crucibles). The use of graphitic bodies formed by high shear mixing and working as described above (and as described in GB 2240006) for such purposes is not known and the present invention covers such uses. The molten metal contacting apparatus may be or comprise crucibles and may be or comprise a liner for crucibles and other molten metal contacting apparatus.

Production of pliable graphitic sheets in such a readily processable form makes it possible to make a graphitic analogue to corrugated cardboard, in which plane sheets are adhesively secured to a corrugated sheet inner. This gives a high strength, low weight, material having a high thermal conductivity in its plane with a low thermal conductivity through plane and useful as a heat shield or for other applications (e.g. as a heat exchange medium). As discussed in GB 2240006, the adhesive used may be a material that carbonises on curing to provide a carbon bond between the sheets.

GB 2240006 discusses the good acoustic properties of graphite materials and accordingly the present invention extends to a diaphragm for use in acoustic equipment comprising a graphitic body formed by the method of the present invention.

Graphite and carbon based materials are conventionally used as electrodes in a variety of apparatus and industrial processes as they have good electrical conductivity and a degree of chemical inertness. Accordingly the present invention extends to an electrode comprising a graphitic body formed by high shear mixing and working as described above (and as described in GB 2240006).

Carbon or graphite materials are also used in the production of silicon carbide by exposing a porous carbon article to SiO vapour to convert the carbon to silicon carbide. Accordingly, the present invention extends to a precursor for use in the manufacture of silicon carbide by silicising, comprising a graphitic body formed by high shear mixing and working as described above (and as described in GB 2240006). The invention also extends to silicon carbide articles formed from such precursors.

The applicants have also found that secondary phases (e.g. silicon carbide) can be rolled into the surface of the material prior to curing. Accordingly the present invention extends to a graphitic body having a coating of a secondary phase, formed by the process of:—

a) forming under high shear a mouldable composition comprising:—

i) graphite powder;

ii) a binder; and

iii) a fluid carrier

b) working said mouldable composition under high shear to form an extruded shape;

c) forming bodies from said shape;

d) incorporating said secondary phase into the surface of the extruded shape either before or after forming bodies from said shape; and

d) heat treating said bodies to stabilise the structure.

Silicon carbide is a suitable secondary phase as it has a similar coefficient of thermal expansion to graphite and provides a hardened surface to the graphite body. Other materials (e.g. silicon nitride or boron nitride) might be included if an electrically non-conductive surface is required.

The process described above also lends itself to manufacture of other carbon based materials in which the loading of graphite is less than 30%.

1. A method of forming graphitic bodies comprising the steps of:—
a) forming under high shear a mouldable composition comprising:—
i) graphite powder;
ii) a binder; and
iii) an aqueous fluid carrier
b) working said mouldable composition under high shear to form an extruded shape;
c) forming bodies from said shape; and
d) heat treating said bodies to stabilise the structure.

2. The method of claim 1, in which, after heat treatment, the bodies are machined to form features in their surfaces.

3. The method of claim 1, in which before heat treatment, the bodies are machined to form features in their surfaces.

4. The method of any one of claims 1, 2, or 3, in which the bodies are impregnated to close porosity in the bodies.

5. The method of any one of claims 1 to 4, in which the binder comprises a polyvinyl alcohol.

6. The method of any one of claims 1 to 4, in which the binder comprises a lignosulphonate.

7. The method of any one of claims 1 to 4, in which the binder comprises a polyvinyl alcohol and a lignosulphonate.

8. The method of any one of claims 1 to 7, in which the bodies are graphitic sheets.

9. The method of any one of claims 1 to 8, in which the step of working the mouldable composition comprises extrusion through an aperture having at least one dimension less than 4 mm.

10. The method of claim 9, in which the step of working the mouldable composition comprises extension through an aperture having at least one dimension less than 3.5 mm

11. The method of claim 10, in which the step of working the mouldable composition comprises extrusion through an aperture having at least one dimension less than 2.5 mm

12. The method of claim 11, in which the step of working the mouldable composition comprises extrusion through an aperture having at least one dimension less than 1.5 mm.

13. The method of any one of claims 1 to 12, in which the body is in the form of a plate.

14. The method of any of claims 1 to 12, in which the shape is produced in the form of a tube.

15. The method of claim 14, in which the tube is split lengthwise and flattened to form a sheet.

16. The method of any one of claims 1 to 15, in which the body is rolled to form a sheet of specified thickness.

17. The method of any one of claims 1 to 16, in which features are formed in the bodies in a rolling process.

18. The method of any one of claims 1 to 16, in which features are formed in the bodies in a die stamping process.

19. The method of any one of claims 1 to 18, in which a mesh of metal or plastics is pressed into the graphitic material to form a composite body.

20. The method of any one of claims 1 to 19, in which the mouldable composition comprises a plasticiser.

21. The method of claim 20, in which the mouldable composition comprises a plasticiser which is also a binder.

22. The method of claim 20 or claim 21, in which the plasticiser is a lignosulphonate.

23. The method of any one of claims 1 to 21, in which the binder is mixed with the graphite powder as dry ingredients prior to mixing with the fluid carrier.

24. The method of any one of claims 1 to 23, in which a dispersant is used to prevent aggregation of the binder.

25. The method of any one of claims 1 to 24, in which the mouldable composition is de-aired prior to worlding the mouldable composition under high shear to form the extruded shape.

26. The method of any one of claims 1 to 25, in which the mouldable composition comprises a filler.

27. The method of claim 26, in which the filler comprises a carbonaceous filler.

28. The method of any one of claims 1 to 27, in which the amount of graphite expressed as a dry weight percentage of the mouldable composition is in excess of 30%.

29. The method of claim 28, in which the amount of graphite expressed as a dry weight percentage of the mouldable composition is in excess of 60%.

30. the method of claim 29, in which the amount of graphite expressed as a dry weight percentage of the mouldable composition is in excess of 80%.

31. The method of claim 30, in which the mouldable composition comprises in weight percent (as a proportion of the components excluding the fluid carrier):—
Graphite 80-90%
Binder 10-20%
Plasticiser 0-10%.
to which a fluid carrier in amounts in the range 10-40% by weight of the total of said components is added in mixing.

32. The method of claim 31, in which the amount of fluid carrier is in the range 15-35%.

33. A mouldable composition, as described in any one of claims 1 to 32, housed in a container to prevent loss of fluid during storage.

34. A mouldable composition, as claimed in claim 33, in which the composition is in the form of a pliable sheet

35. Use of a mouldable composition, as claimed in claim 33 or claim 34, as a mouldable graphitic material that can be formed to shape and air dried to set

36. A graphitic component for a fuel cell, formed by a method comprising the steps of:—
a) forming under high shear a mouldable composition comprising:—
i) graphite powder,
ii) a binder; and
iii) an aqueous fluid carrier
b) worlding said mouldable composition under high shear to form an extruded shape;
c) forming the graphitic component from said shape;
d) heat treating said graphitic component to stabilise the structure.

37. A graphitic component, as claimed in claim 36, comprising flow fields formed in the graphitic component either before or after heat treating said graphitic component.

38. A graphitic component, as claimed in claim 36 or 37, in which an impregnated material closes porosity in the graphitic component.

39. A bipolar plate for a fuel cell, comprising a graphitic component as claimed in any one of claims 36 to 38,

40. A heat shield comprising a graphitic body, formed by a method comprising the steps of:—
a) forming under high shear a mouldable composition comprising:—
i) graphite powder,
ii) a binder; and
iii) an aqueous fluid carrier
b) working said mouldable composition under high shear to form an extruded shape;
c) forming bodies from said shape; and
d) heat treating said bodies to stabilise the structure.

41. A heat spreader comprising a graphitic body, formed by a method comprising the steps of:—
a) forming under high shear a mouldable composition comprising:—
i) graphite powder;
ii) a binder; and
iii) an aqueous fluid carrier
b) working said mouldable composition under high shear to form an extruded shape;
c) forming bodies from said shape; and
d) heat treating said bodies to stabilise the structure.

42. Molten metal contacting apparatus comprising a graphitic body, formed by a method comprising the steps of:—
a) forming under high shear a mouldable composition comprising:—
i) graphite powder;
ii) a binder; and
iii) an aqueous fluid carrier
b) working said mouldable composition under high shear to form an extruded shape;
c) forming bodies from said shape; and
d) heat treating said bodies to stabilise the structure.

43. Molten metal contacting apparatus as claimed in claim 42, in which the apparatus is or comprises a crucible.

44. Molten metal contacting apparatus as claimed in claim 42, in which the apparatus is or comprises a liner, for a crucible or other molten metal contacting apparatus.

45. An electrode comprising a graphitic body, formed by a method comprising the steps of:—
a) forming under high shear a mouldable composition comprising:—
i) graphite powder;
ii) a binder, and
iii) an aqueous fluid carrier
b) working said mouldable composition under high shear to form an extruded shape;
c) forming bodies from said shape; and
d) heat treating said bodies to stabilise the structure.

46. A composite sheet comprising a porous core and a graphitic sheet coating, the graphitic sheet coating being formed by the method comprising the steps of:—
a) forming under high shear a mouldable composition comprising:—
i) graphite powder;
ii) a binder, and
iii) an aqueous fluid carrier
b) working said mouldable composition under high shear to form an extruded shape;
c) forming bodies from said shape; and
d) heat treating said bodies to stabilise the structure.

47. A composite sheet as claimed in claim 46, comprising a felt of graphitic material secured between sheets of graphitic material.

48. A composite sheet as claimed in claim 46, comprising a corrugated sheet of graphitic material secured between sheets of graphitic material.

49. A composite sheet, as claimed in any of claims 46 to 48, in which the porous core is secured between the sheets of graphitic material prior to heat treatment of the sheets of graphitic material.

50. A composite sheet, as claimed in claim 49, in which the porous core is rolled between said extruded shapes prior to forming the bodies.

51. A composite sheet comprising a mesh of metal or plastics fully or partially embedded in a matrix of graphitic material produced by the steps of:—
a) forming under high shear a mouldable composition comprising:—
i) graphite powder;
ii) a binder, and
iii) an aqueous fluid carrier
b) working said mouldable composition under high shear to form an extruded shape;
c) forming bodies from said shape; and
d) heat treating said bodies to stabilise the structure.

52. A precursor for use in the manufacture of silicon carbide by silicising, comprising a body of graphitic material produced by the steps of:—
a) forming under high shear a mouldable composition comprising:—
i) graphite powder;
ii) a binder; and
iii) an aqueous fluid carrier
b) working said mouldable composition under high shear to form an extruded shape;
c) forming bodies from said shape; and
d) heat treating said bodies to stabilise the structure.

53. A silicon carbide article produced by silicising a precursor as claimed in claim 52.

54. A graphite body having a coating of a secondary phase, formed by the process of:—
a) forming under high shear a mouldable composition comprising:—
i) graphite powder,
ii) a binder; and
iii) an aqueous fluid carrier
b) working said mouldable composition under high shear to form an extruded shape;
c) forming bodies from said shape;
d) incorporating said secondary phase into the surface of the extruded shape either before or after forming bodies from said shape; and
d) heat treating said bodies to stabilise the structure.

55. A graphite body having a coating of a secondary phase, as claimed in claim 54, in which the secondary phase is or includes silicon carbide.

56. A graphite body having a coating of a secondary phase, as claimed in claim 54, in which the secondary phase is or includes silicon nitride or boron nitride.

57. A graphite body comprising a temporary secondary phase, formed by the process of:—
a) forming under high shear a mouldable composition comprising:—
i) graphite powder;
ii) a binder, and
iii) an aqueous fluid carrier
b) working said mouldable composition under high shear to form an extruded shape;
c) forming bodies from said shape; and
d) heat treating said bodies to stabilise the structure
in which said secondary phase is incorporated into the bodies either before heat treatment.
